(19) United States
(12) Patent Application Publication
(10) Pub. No.: US 2026/0243932 A1
(43) Pub. Date: Aug. 20, 2026

(54) METHOD OF MANUFACTURING RELIEF-TYPE DIFFRACTION GRATING

(71) Applicant: MITSUBISHI ELECTRIC CORPORATION, Tokyo (JP)

(72) Inventors: Yoshiaki HIRATA, Chiyoda-ku, Tokyo (JP); Yoshitaka KAJIYAMA, Chiyoda-ku, Tokyo (JP); Misaki HANAOKA, Chiyoda-ku, Tokyo (JP)

(73) Assignee: MITSUBISHI ELECTRIC CORPORATION, Tokyo (JP)

(21) Appl. No.: 19/162,073

(22) PCT Filed: Apr. 21, 2023
(86) PCT No.: PCT/JP2023/015925

§ 371 Date: Sep. 4, 2025

(51) Int. Cl. G02B 5/18

(52) U.S. Cl. CPC G02B 5/1857; G02B 5/1861

(57) ABSTRACT

A method of manufacturing a relief-type diffraction grating includes forming a first silicon nitride film on a silicon member, oxidizing the silicon member using the first silicon nitride film as a mask to change a part of the silicon member into a first silicon oxide film, removing the first silicon nitride film, and selectively removing the first silicon oxide film to form a first step portion in the silicon member.

### TECHNICAL FIELD

The present disclosure relates to a method of manufacturing a relief-type diffraction grating.

### BACKGROUND ART

Japanese Patent Laying-Open No. 2000-105307 (PTL 1) discloses a method of manufacturing a stepped relief-type diffraction grating by etching a glass substrate using a photoresist as a mask. Japanese Patent Laying-Open No. 2000-155207 (PTL 2) discloses a method of manufacturing a stepped relief-type diffraction grating by etching a stack of a SiO₂ film and an Al₂O₃ film using a photoresist as a mask.

### CITATION LIST

### Patent Literature

PTL 1: Japanese Patent Laying-Open No. 2000-105307
PTL 2: Japanese Patent Laying-Open No. 2000-155207

### SUMMARY OF INVENTION

### Technical Problem

In etching using a photoresist, however, the dimensional accuracy of a diffraction grating decreases as a protrusion of a periodic uneven structure of a diffraction grating becomes higher. The present disclosure has been made in view of the problem described above. An object of the present disclosure is to provide a method of manufacturing a relief-type diffraction grating having higher dimensional accuracy.

### Solution to Problem

A method of manufacturing a relief-type diffraction grating of the present disclosure includes forming a first silicon nitride film on a silicon member, oxidizing the silicon member using the first silicon nitride film as a mask to change a part of the silicon member into a first silicon oxide film, removing the first silicon nitride film, and selectively removing the first silicon oxide film to form a first step portion in the silicon member.

### Advantageous Effects of Invention

Oxidation of the silicon member using the first silicon nitride film as a mask can form the first silicon oxide film with higher dimensional accuracy. Then, selective removal of the first silicon oxide film manufactures a relief-type diffraction grating. The method of manufacturing a relief-type diffraction grating according to the present embodiment can manufacture a relief-type diffraction grating with higher dimensional accuracy.

### BRIEF DESCRIPTION OF DRAWINGS

FIG. 1 is a schematic partial sectional view of a relief-type diffraction grating of Embodiment 1.

FIG. 2 is an enlarged schematic partial sectional view of the relief-type diffraction grating of Embodiment 1.

FIG. 3 is an enlarged schematic partial sectional view showing a step of a method of manufacturing a relief-type diffraction grating of Embodiment 1.

FIG. 4 is an enlarged schematic partial sectional view showing a step following the step shown in FIG. 3 in the method of manufacturing a relief-type diffraction grating of Embodiment 1.

FIG. 5 is an enlarged schematic partial sectional view showing a step following the step shown in FIG. 4 in the method of manufacturing a relief-type diffraction grating of Embodiment 1.

FIG. 6 is an enlarged schematic partial sectional view showing a step following the step shown in FIG. 5 in the method of manufacturing a relief-type diffraction grating of Embodiment 1.

FIG. 7 is an enlarged schematic partial sectional view showing a step following the step shown in FIG. 6 in the method of manufacturing a relief-type diffraction grating of Embodiment 1.

FIG. 8 is an enlarged schematic partial sectional view showing a step following the step shown in FIG. 7 in the method of manufacturing a relief-type diffraction grating of Embodiment 1.

FIG. 9 is an enlarged schematic partial sectional view showing a step following the step shown in FIG. 8 in the method of manufacturing a relief-type diffraction grating of Embodiment 1.

FIG. 10 is an enlarged schematic partial sectional view showing a step following the step shown in FIG. 9 in the method of manufacturing a relief-type diffraction grating of Embodiment 1.

FIG. 11 is an enlarged schematic partial sectional view showing a step following the step shown in FIG. 10 in the method of manufacturing a relief-type diffraction grating of Embodiment 1.

FIG. 12 is an enlarged schematic partial sectional view showing a step following the step shown in FIG. 11 in the method of manufacturing a relief-type diffraction grating of Embodiment 1.

FIG. 13 is an enlarged schematic partial sectional view showing a step following the step shown in FIG. 12 in the method of manufacturing a relief-type diffraction grating of Embodiment 1.

FIG. 14 is an enlarged schematic partial sectional view showing a step following the step shown in FIG. 13 in the method of manufacturing a relief-type diffraction grating of Embodiment 1.

FIG. 15 is an enlarged schematic partial sectional view showing a step following the step shown in FIG. 14 in the method of manufacturing a relief-type diffraction grating of Embodiment 1.

FIG. 16 is an enlarged schematic partial sectional view showing a step following the step shown in FIG. 15 in the method of manufacturing a relief-type diffraction grating of Embodiment 1.

FIG. 17 is an enlarged schematic partial sectional view showing a step following the step shown in FIG. 16 in the method of manufacturing a relief-type diffraction grating of Embodiment 1.

FIG. 18 is a schematic partial sectional view of a relief-type diffraction grating of Embodiment 2.

FIG. 19 is an enlarged schematic partial sectional view of the relief-type diffraction grating of Embodiment 2.

FIG. 20 is an enlarged schematic partial sectional view showing a step of a method of manufacturing a relief-type diffraction grating of Embodiment 2.

FIG. 21 is an enlarged schematic partial sectional view showing a step following the step shown in FIG. 20 in the method of manufacturing a relief-type diffraction grating of Embodiment 2.

FIG. 22 is an enlarged schematic partial sectional view showing a step following the step shown in FIG. 21 in the method of manufacturing a relief-type diffraction grating of Embodiment 2.

FIG. 23 is an enlarged schematic partial sectional view showing a step following the step shown in FIG. 22 in the method of manufacturing a relief-type diffraction grating of Embodiment 2.

FIG. 24 is an enlarged schematic partial sectional view showing a step following the step shown in FIG. 23 in the method of manufacturing a relief-type diffraction grating of Embodiment 2.

FIG. 25 is an enlarged schematic partial sectional view showing a step following the step shown in FIG. 24 in the method of manufacturing a relief-type diffraction grating of Embodiment 2.

FIG. 26 is an enlarged schematic partial sectional view showing a step following the step shown in FIG. 25 in the method of manufacturing a relief-type diffraction grating of Embodiment 2.

FIG. 27 is an enlarged schematic partial sectional view showing a step following the step shown in FIG. 26 in the method of manufacturing a relief-type diffraction grating of Embodiment 2.

FIG. 28 is an enlarged schematic partial sectional view showing a step following the step shown in FIG. 27 in the method of manufacturing a relief-type diffraction grating of Embodiment 2.

FIG. 29 is an enlarged schematic partial sectional view showing a step following the step shown in FIG. 28 in the method of manufacturing a relief-type diffraction grating of Embodiment 2.

FIG. 30 is an enlarged schematic partial sectional view showing a step following the step shown in FIG. 29 in the method of manufacturing a relief-type diffraction grating of Embodiment 2.

FIG. 31 is an enlarged schematic partial sectional view showing a step following the step shown in FIG. 30 in the method of manufacturing a relief-type diffraction grating of Embodiment 2.

FIG. 32 is an enlarged schematic partial sectional view showing a step following the step shown in FIG. 31 in the method of manufacturing a relief-type diffraction grating of Embodiment 2.

FIG. 33 is an enlarged schematic partial sectional view showing a step following the step shown in FIG. 32 in the method of manufacturing a relief-type diffraction grating of Embodiment 2.

FIG. 34 is an enlarged schematic partial sectional view showing a step following the step shown in FIG. 33 in the method of manufacturing a relief-type diffraction grating of Embodiment 2.

FIG. 35 is a schematic partial sectional view of a relief-type diffraction grating of Embodiment 3.

FIG. 36 is an enlarged schematic partial sectional view of the relief-type diffraction grating of Embodiment 3.

FIG. 37 is an enlarged schematic partial sectional view showing a step of manufacturing a relief-type diffraction grating of Embodiment 3.

FIG. 38 is an enlarged schematic partial sectional view showing a step following the step shown in FIG. 37 in the method of manufacturing a relief-type diffraction grating of Embodiment 3.

FIG. 39 is an enlarged schematic partial sectional view showing a step following the step shown in FIG. 38 in the method of manufacturing a relief-type diffraction grating of Embodiment 3.

FIG. 40 is an enlarged schematic partial sectional view showing a step following the step shown in FIG. 39 in the method of manufacturing a relief-type diffraction grating of Embodiment 3.

FIG. 41 is an enlarged schematic partial sectional view showing a step following the step shown in FIG. 40 in the method of manufacturing a relief-type diffraction grating of Embodiment 3.

FIG. 42 is an enlarged schematic partial sectional view showing a step following the step shown in FIG. 41 in the method of manufacturing a relief-type diffraction grating of Embodiment 3.

FIG. 43 is an enlarged schematic partial sectional view showing a step following the step shown in FIG. 42 in the method of manufacturing a relief-type diffraction grating of Embodiment 3.

FIG. 44 is an enlarged schematic partial sectional view showing a step following the step shown in FIG. 43 in the method of manufacturing a relief-type diffraction grating of Embodiment 3.

FIG. 45 is an enlarged schematic partial sectional view showing a step following the step shown in FIG. 44 in the method of manufacturing a relief-type diffraction grating of Embodiment 3.

FIG. 46 is an enlarged schematic partial sectional view showing a step following the step shown in FIG. 45 in the method of manufacturing a relief-type diffraction grating of Embodiment 3.

FIG. 47 is an enlarged schematic partial sectional view showing a step following the step shown in FIG. 46 in the method of manufacturing a relief-type diffraction grating of Embodiment 3.

FIG. 48 is an enlarged schematic partial sectional view showing a step following the step shown in FIG. 47 in the method of manufacturing a relief-type diffraction grating of Embodiment 3.

FIG. 49 is an enlarged schematic partial sectional view showing a step following the step shown in FIG. 48 in the method of manufacturing a relief-type diffraction grating of Embodiment 3.

FIG. 50 is a schematic partial sectional view of a relief-type diffraction grating of Embodiment 4.

FIG. 51 is an enlarged schematic partial sectional view of the relief-type diffraction grating of Embodiment 4.

FIG. 52 is an enlarged schematic partial sectional view showing a step of a method of manufacturing a relief-type diffraction grating of Embodiment 4.

FIG. 53 is an enlarged schematic partial sectional view showing a step following the step shown in FIG. 52 in the method of manufacturing a relief-type diffraction grating of Embodiment 4.

FIG. 54 is an enlarged schematic partial sectional view showing a step following the step shown in FIG. 53 in the method of manufacturing a relief-type diffraction grating of Embodiment 4.

FIG. 55 is a schematic plan view of an optical scanning device of Embodiment 5.

### DESCRIPTION OF EMBODIMENTS

Embodiments of the present disclosure will be described below. The same components have the same reference characters allotted, and description thereof will not be repeated.

### Embodiment 1

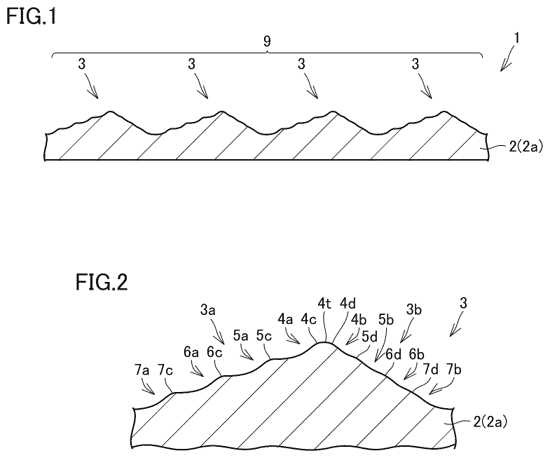

A relief-type diffraction grating 1 of Embodiment 1 will be described with reference to FIGS. 1 and 2. A diffraction wavelength of relief-type diffraction grating 1 is in, for example, the wavelength range from infrared rays to far-infrared rays.

Relief-type diffraction grating 1 includes a silicon member 2 and a periodic uneven structure 9 formed in silicon member 2. Relief-type diffraction grating 1 may further include a reflective film (not shown) provided on the surface of periodic uneven structure 9. The reflective film is formed of, for example, a metal.

Relief-type diffraction grating 1 is formed in silicon member 2. In the present embodiment, silicon member 2 is a silicon substrate 2a.

Periodic uneven structure 9 includes a plurality of protrusions 3 disposed periodically. Each of protrusions 3 includes a side surface 3a, a side surface 3b that faces side surface 3a, and a top surface 4t. Top surface 4t is disposed between side surface 3a and side surface 3b and is connected to side surface 3a and side surface 3b.

In the present embodiment, each of protrusions 3 has a plurality of height levels. Relief-type diffraction grating 1 is a stepped diffraction grating having a plurality of height levels. Specifically, each of protrusions 3 has, for example, four height levels. Each of protrusions 3 includes step portions 4a, 4b, 5a, 5b, 6a, 6b, 7a, 7b.

Step portions 4a, 5a, 6a, 7a are provided in side surface 3a. Step portion 4a is the uppermost step portion of step portions 4a, 5a, 6a, 7a. Step portion 5a is the second uppermost step portion of step portions 4a, 5a, 6a, 7a. Step portion 6a is the second undermost step portion of step portions 4a, 5a, 6a, 7a. Step portion 7a is the undermost step portion of step portions 4a, 5a, 6a, 7a.

Step portions 4b, 5b, 6b, 7b are provided in side surface 3b. Step portion 4b is the uppermost step portion of step portions 4b, 5b, 6b, 7b. Step portion 5b is the second uppermost step portion of step portions 4b, 5b, 6b, 7b. Step portion 6b is the second undermost step portion of step portions 4b, 5b, 6b, 7b. Step portion 7b is the undermost step portion of step portions 4b, 5b, 6b, 7b.

Step portion 4b faces step portion 4a in the in-plane direction (right-left direction in FIG. 2) perpendicular to the height direction (the upward-downward direction in FIG. 2) of each of protrusions 3. Step portion 5b faces step portion 5a in the in-plane direction. Step portion 6b faces step portion 6a in the in-plane direction. Step portion 7b faces step portion 7a in the in-plane direction. Top surface 4t is disposed between step portion 4a and step portion 4b and is connected to step portion 4a and step portion 4b.

Step portion 4a has a smooth edge portion 4c. Step portion 4b has a smooth edge portion 4d. Step portion 5a has a smooth edge portion 5c. Step portion 5b has a smooth edge portion 5d. Step portion 6a has a smooth edge portion 6c. Step portion 6b has a smooth edge portion 6d. Step portion 7a has a smooth edge portion 7c. Step portion 7b has a smooth edge portion 7d. In this specification, the smooth edge portion means that the minimum radius of curvature of the edge portion is at least greater than or equal to one-tenth of the diffraction wavelength of relief-type diffraction grating 1.

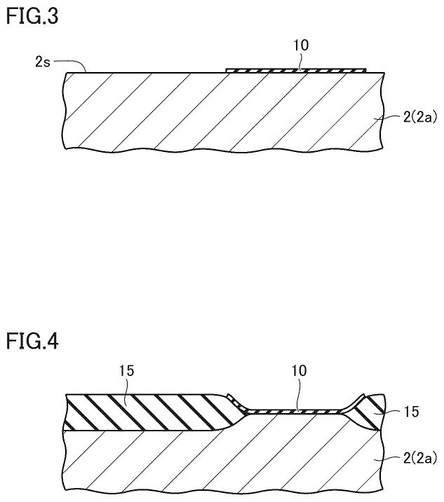

A method of manufacturing relief-type diffraction grating 1 of the present embodiment will be described with reference to FIGS. 3 to 18.

Referring to FIG. 3, a silicon nitride film 10 is formed on a main surface 2s of silicon member 2. A part of main surface 2s of silicon member 2 is covered with silicon nitride film 10. The remaining part of main surface 2s of silicon member 2 is exposed from silicon nitride film 10.

For example, a silicon nitride film is formed on the entire main surface 2s of silicon member 2 by low-pressure chemical vapor deposition (LPCVD). A photoresist (not shown) is applied to the silicon nitride film. The photoresist is exposed to light and developed to pattern the photoresist. A portion of the silicon nitride film which is exposed from the photoresist is removed by dry etching using CF-based plasma or the like or by wet etching using a hot phosphoric acid or the like. The photoresist is removed from silicon member 2 using oxygen plasma or an organic solvent such as acetone. In this way, silicon nitride film 10 is formed on a part of main surface 2s of silicon member 2. The silicon nitride film formed by LPCVD can withstand the step of oxidizing silicon member 2 (see FIG. 4). The thickness of silicon nitride film 10 is in the range of, for example, 0.1 μm to 0.3 μm, which is smaller than the thickness of the photoresist (1 μm or more).

Referring to FIG. 4, silicon member 2 is placed in a thermal oxidation furnace (not shown). Using silicon nitride film 10 as a mask, a part of silicon member 2 is oxidized (locally oxidized) to change the part of silicon member 2 into a silicon oxide film 15. Specifically, a portion of silicon member 2, which is exposed from silicon nitride film 10, and a portion of silicon member 2, which is located under the peripheral edge portion of silicon nitride film 10, are changed into silicon oxide film 15. Silicon oxide film 15 is formed to wrap around below the peripheral edge portion of silicon nitride film 10 and lifts up the peripheral edge portion of silicon nitride film 10.

Wrapping around below the peripheral edge portion of silicon nitride film 10 by silicon oxide film 15 can be achieved with high reproducibility and high dimensional accuracy. Silicon member 2 is taken out of the thermal oxidation furnace.

Referring to FIG. 5, silicon nitride film 10 is selectively removed by dry etching using CF-based plasma or the like or by wet etching using a hot phosphoric acid or the like.

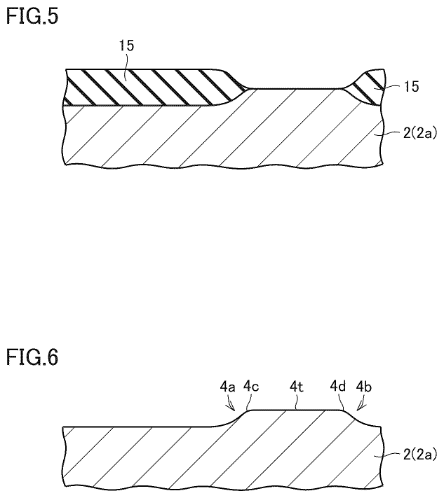

Referring to FIG. 6, silicon oxide film 15 is selectively removed by a hydrofluoric acid solution, a hydrofluoric acid vapor, or the like to form step portions 4a, 4b in silicon member 2. Step portion 4a has smooth edge portion 4c. Step portion 4b has smooth edge portion 4d. Edge portions 4c, 4d of step portion 4a, 4b are smoothed by a local oxidation step (see FIG. 4) and a step of selectively removing a silicon oxide film (see FIG. 6). Top surface 4t is a part of main surface 2s (see FIG. 3) of silicon member 2 and is flat similarly to main surface 2s.

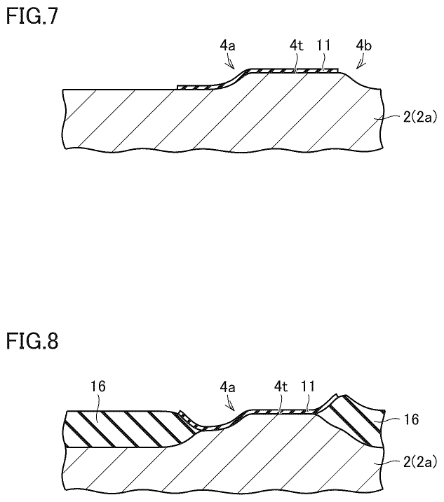

Referring to FIG. 7, a silicon nitride film 11 is formed on top surface 4t of silicon member 2 and on step portion 4a. Step portion 4b and a portion of silicon member 2, which is opposite to top surface 4t relative to step portion 4a in the in-plane direction (right-left direction in FIG. 7), are exposed from silicon nitride film 11. Silicon nitride film 11 is formed in the same manner as that of silicon nitride film 10. The thickness of silicon nitride film 11 is in the range of, for example, 0.1 μm to 0.3 μm.

Referring to FIG. 8, silicon member 2 is placed in the thermal oxidation furnace (not shown). Using silicon nitride film 11 as a mask, a part of silicon member 2 is oxidized (locally oxidized) to change the part of silicon member 2 into a silicon oxide film 16. Specifically, a portion of silicon member 2, which is exposed from silicon nitride film 11, and a portion of silicon member 2, which is located under the peripheral edge portion of silicon nitride film 11, are changed into silicon oxide film 16. Silicon oxide film 16 is formed to wrap around below the peripheral edge portion of silicon nitride film 11 and lifts up the peripheral edge portion of silicon nitride film 11. Wrapping around below the peripheral edge portion of silicon nitride film 11 by silicon oxide film 16 can be achieved with high reproducibility and high dimensional accuracy. Silicon member 2 is taken out of the thermal oxidation furnace.

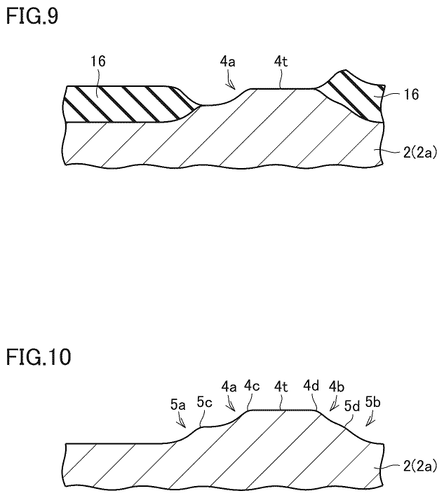

Referring to FIG. 9, silicon nitride film 11 is selectively removed by dry etching using CF-based plasma or the like or by wet etching using a hot phosphoric acid or the like.

Referring to FIG. 10, silicon oxide film 16 is selectively removed by a hydrofluoric acid solution, a hydrofluoric acid vapor, or the like to form step portions 5a, 5b in silicon member 2. Step portion 5a has smooth edge portion 5c. Step portion 5b has smooth edge portion 5d. Edge portions 5c, 5d of step portions 5a, 5b are smoothed by a local oxidation step (see FIG. 8) and a step of selectively removing a silicon oxide film (see FIG. 10).

Referring to FIG. 11, a silicon nitride film 12 is formed on top surface 4t of silicon member 2 and on step portions 4a, 5a. Step portions 4b, 5b and a portion of silicon member 2, which is opposite to top surface 4t relative to step portion 5a in the in-plane direction (right-left direction in FIG. 11), are exposed from silicon nitride film 12. Silicon nitride film 12 is formed in the same manner as that of silicon nitride film 10. The thickness of silicon nitride film 12 is in the range of, for example, 0.1 μm to 0.3 μm.

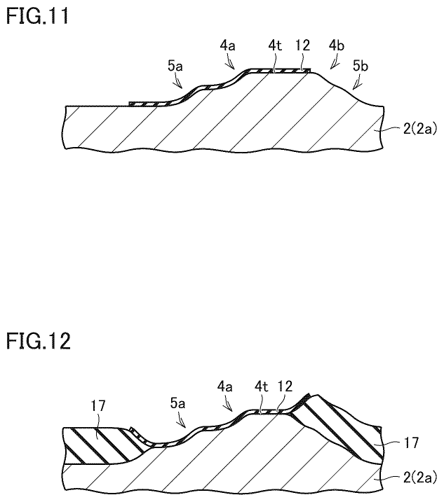

Referring to FIG. 12, silicon member 2 is placed in the thermal oxidation furnace (not shown). Using silicon nitride film 12 as a mask, a part of silicon member 2 is oxidized (locally oxidized) to change the part of silicon member 2 into a silicon oxide film 17. Specifically, a portion of silicon member 2, which is exposed from silicon nitride film 12, and a portion of silicon member 2, which is located under the peripheral edge portion of silicon nitride film 12, are changed into silicon oxide film 17. Silicon oxide film 17 is formed to wrap around below the peripheral edge portion of silicon nitride film 12 and lifts up the peripheral edge portion of silicon nitride film 12. Wrapping around below the peripheral edge portion of silicon nitride film 12 by silicon oxide film 17 can be achieved with high reproducibility and high dimensional accuracy. Silicon member 2 is taken out of the thermal oxidation furnace.

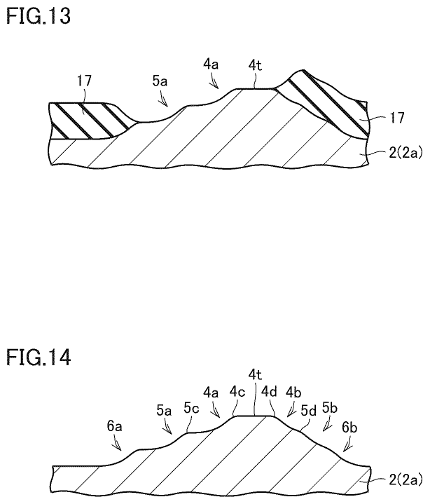

Referring to FIG. 13, silicon nitride film 12 is selectively removed by dry etching using CF-based plasma or the like or by wet etching using a hot phosphoric acid or the like.

Referring to FIG. 14, silicon oxide film 17 is selectively removed by a hydrofluoric acid solution, a hydrofluoric acid vapor, or the like to form step portions 6a, 6b in silicon member 2. Step portion 6a has smooth edge portion 6c. Step portion 6b has smooth edge portion 6d. Edge portions 6c, 6d of step portions 6a, 6b are smoothed by a local oxidation step (see FIG. 12) and a step of selectively removing a silicon oxide film (see FIG. 14).

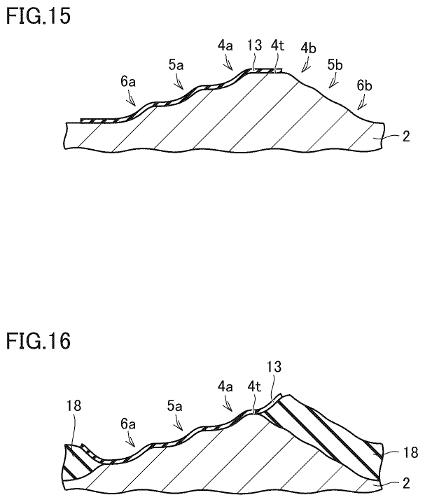

Referring to FIG. 15, a silicon nitride film 13 is formed on top surface 4t of silicon member 2 and on step portions 4a, 5a, 6a. Step portions 4b, 5b, 6b and a portion of silicon member 2, which is opposite to top surface 4t relative to step portion 6a in the in-plane direction (right-left direction in FIG. 15), are exposed from silicon nitride film 13. Silicon nitride film 13 is formed in the same manner as that of silicon nitride film 10. The thickness of silicon nitride film 13 is in the range of, for example, 0.1 μm to 0.3 μm.

Referring to FIG. 16, silicon member 2 is placed in the thermal oxidation furnace (not shown). Using silicon nitride film 13 as a mask, a part of silicon member 2 is oxidized (locally oxidized) to change the part of silicon member 2 into a silicon oxide film 18. Specifically, a portion of silicon member 2, which is exposed from silicon nitride film 13, and a portion of silicon member 2, which is located under the peripheral edge portion of silicon nitride film 13, are changed into silicon oxide film 18. Silicon oxide film 18 is formed to wrap around below the peripheral edge portion of silicon nitride film 13 and lifts up the peripheral edge portion of silicon nitride film 13. Wrapping around below the peripheral edge portion of silicon nitride film 13 by silicon oxide film 18 can be achieved with high reproducibility and high dimensional accuracy. Silicon member 2 is taken out of the thermal oxidation furnace.

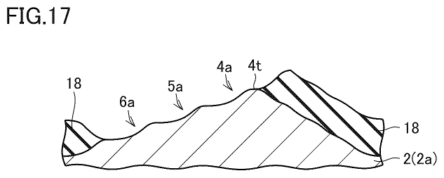

Referring to FIG. 17, silicon nitride film 13 is selectively removed by dry etching using CF-based plasma or the like or by wet etching using a hot phosphoric acid or the like.

Silicon oxide film 18 is selectively removed by a hydrofluoric acid solution, a hydrofluoric acid vapor, or the like to form step portions 7a, 7b (see FIG. 2) in silicon member 2. Step portion 7a has smooth edge portion 7c. Step portion 7b has smooth edge portion 7d. Edge portions 7c, 7d of step portions 7a, 7b are smoothed by a local oxidation step (see FIG. 16) and a step of selectively removing a silicon oxide film. Thus, relief-type diffraction grating 1 shown in FIGS. 1 and 2 is obtained.

In the present embodiment, the local oxidation step and the step of selectively removing a silicon oxide film are each performed four times in order to form four step portions 4a, 5a, 6a, 7a and four step portions 4b, 5b, 6b, 7b, but the local oxidation step and the step of selectively removing a silicon oxide film may be each performed n number of times (where n is a natural number) in order to form n number of step portions.

The advantageous effects of the method of manufacturing relief-type diffraction grating 1 of the present embodiment will be described.

The method of manufacturing relief-type diffraction grating 1 of the present embodiment includes the steps of: forming a first silicon nitride film (e.g., silicon nitride film 10) on silicon member 2; oxidizing silicon member 2 using the first silicon nitride film as a mask to change a part of silicon member 2 into a first silicon oxide film (e.g., silicon oxide film 15); removing the first silicon nitride film; and selectively removing the first silicon oxide film to form a first step portion (e.g., step portion 4a) in silicon member 2.

Oxidation (local oxidation) of silicon member 2 using the first silicon nitride film as a mask can form the first silicon oxide film (e.g., silicon oxide film 15) with higher dimensional accuracy. Then, selective removal of the first silicon oxide film manufactures relief-type diffraction grating 1. As a result, the dimensional accuracy of the diffraction grating in the height direction of the diffraction grating and the dimensional accuracy of the diffraction grating in the in-plane direction of the diffraction grating, which is perpendicular to the height direction of the diffraction grating, are improved. The method of manufacturing relief-type diffraction grating 1 according to the present embodiment can manufacture relief-type diffraction grating 1 with higher dimensional accuracy.

When the surface of the diffraction grating is formed by etching or deposition, the surface of the diffraction grating becomes rough. Light scattering occurs in the surface of the diffraction grating, reducing the diffraction efficiency of the diffraction grating. In contrast, the surface of silicon member 2 formed by selectively removing the first silicon oxide film (e.g., silicon oxide film 15) as in the present embodiment has higher smoothness. Light scattering in the surface of the diffraction grating is suppressed. The method of manufacturing relief-type diffraction grating 1 according to the present embodiment can manufacture relief-type diffraction grating 1 having higher diffraction efficiency.

Relief-type diffraction grating 1 of the present embodiment is formed in silicon member 2 formed of a single material, that is, silicon. Thus, the method of manufacturing relief-type diffraction grating 1 according to the present embodiment can manufacture relief-type diffraction grating 1 with excellent temperature stability of diffraction efficiency compared to a relief-type diffraction grating of a comparative example, which is formed of a plurality of materials with different linear expansion coefficients.

In the method of manufacturing relief-type diffraction grating 1 of the present embodiment, the first step portion (e.g., step portion 4a) has a smooth edge portion (e.g., edge portion 4c).

Thus, light scattering at the edge portion (e.g., edge portion 4c) is suppressed. The method of manufacturing relief-type diffraction grating 1 according to the present embodiment can manufacture relief-type diffraction grating 1 having higher diffraction efficiency.

The method of manufacturing relief-type diffraction grating 1 of the present embodiment further includes the steps of: forming a second silicon nitride film (e.g., silicon nitride film 11) on top surface 4 of silicon member 2 connected to the first step portion (e.g., step portion 4a) and on the first step portion; oxidizing silicon member 2 using the second silicon nitride film as a mask to change a part of silicon member 2 into a second silicon oxide film (e.g., silicon oxide film 16); removing the second silicon nitride film; and selectively removing the second silicon oxide film to form a second step portion (e.g., step portion 5a) connected to the first step portion in silicon member 2. Each of protrusions 3 of relief-type diffraction grating 1 has a plurality of height levels.

In order to form protrusion 3, which has a plurality of height levels, by etching using a photoresist as a mask, a thick photoresist patterned is required. When a thick photoresist is patterned by exposure to light and development, the thick photoresist cannot be patterned with high accuracy due to defocusing of the light used for exposure to light. In contrast, in the method of manufacturing relief-type diffraction grating 1 of the present embodiment, a silicon nitride film, which is thinner than the photoresist, is used to form protrusion 3 having a plurality of height levels. Then, oxidization (local oxidation) of silicon member 2 using the silicon nitride film as a mask can form a silicon oxide film with higher dimensional accuracy. Selective removal of the silicon oxide film manufactures relief-type diffraction grating 1. Thus, even if each of protrusions 3 of relief-type diffraction grating 1 has a plurality of height levels, relief-type diffraction grating 1 with higher dimensional accuracy can be manufactured.

In the method of manufacturing relief-type diffraction grating 1 of the present embodiment, silicon member 2 is silicon substrate 2a.

Relief-type diffraction grating 1 of the present embodiment is formed in silicon substrate 2a formed of a single material, that is, silicon. Thus, the method of manufacturing relief-type diffraction grating 1 according to the present embodiment can manufacture relief-type diffraction grating 1 with excellent temperature stability of diffraction efficiency compared to the relief-type diffraction grating of the comparative example, which is formed of a plurality of materials with different linear expansion coefficients.

### Embodiment 2

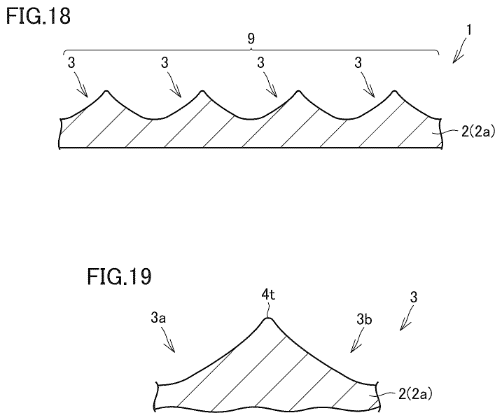

Relief-type diffraction grating 1 of Embodiment 2 will be described with reference to FIGS. 18 and 19. Relief-type diffraction grating 1 of the present embodiment includes a similar configuration to that of relief-type diffraction grating 1 of Embodiment 1 but is different from relief-type diffraction grating 1 of Embodiment 1 in the following respects.

In relief-type diffraction grating 1 of the present embodiment, each of protrusions 3 has a single height level. Relief-type diffraction grating 1 is a diffraction grating having a single height level. Each of protrusions 3 has smooth side surfaces 3a, 3b. In this specification, the smooth side surface means that an arithmetic mean roughness Ra of the side surface is less than or equal to one-tenth of the diffraction wavelength of relief-type diffraction grating 1. Side surfaces 3a, 3b do not have edge portions.

Referring to FIGS. 20 to 34, a method of manufacturing relief-type diffraction grating 1 of the present embodiment will be described.

Referring to FIG. 20, silicon nitride film 10 is formed on main surface 2s of silicon member 2. A part of main surface 2s of silicon member 2 is covered with silicon nitride film 10. The remaining part of main surface 2s of silicon member 2 is exposed from silicon nitride film 10. The step of forming silicon nitride film 10 shown in FIG. 20 is the same as the step of forming silicon nitride film 10 shown in FIG. 3.

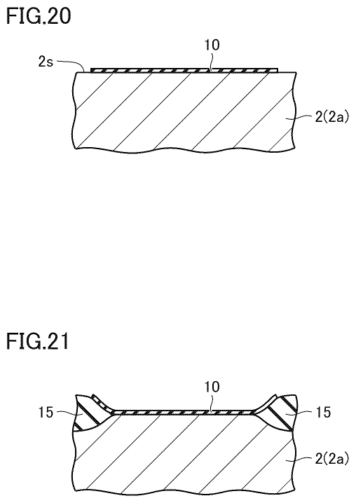

Referring to FIG. 21, using silicon nitride film 10 as a mask, a part of silicon member 2 is oxidized (locally oxidized) to change the part of silicon member 2 into silicon oxide film 15. The local oxidation step shown in FIG. 21 is the same as the local oxidation step shown in FIG. 4.

Referring to FIG. 22, silicon nitride film 10 is selectively removed by dry etching using CF-based plasma or the like or by wet etching using a hot phosphoric acid or the like. The step of removing silicon nitride film 10 shown in FIG. 22 is the same as the step of removing silicon nitride film 10 shown in FIG. 5.

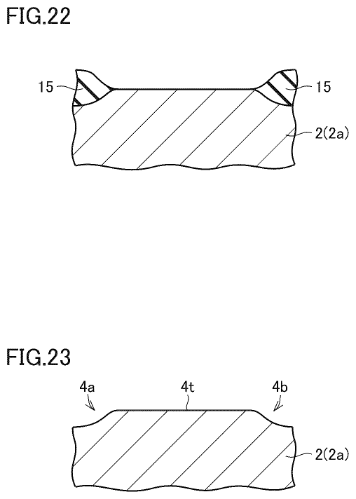

Referring to FIG. 23, silicon oxide film 15 is selectively removed by a hydrofluoric acid solution, a hydrofluoric acid vapor, or the like to form step portions 4a, 4b in silicon member 2. Top surface 4t is a part of main surface 2s (see FIG. 20) of silicon member 2 and is flat similarly to main surface 2s. Top surface 4t is located between step portion 4a and step portion 4b and is connected to step portion 4a and step portion 4b. The step of removing silicon oxide film 15 shown in FIG. 23 is the same as the step of removing silicon oxide film 15 shown in FIG. 6.

Referring to FIG. 24, silicon nitride film 11 is formed on top surface 4t of silicon member 2. Step portions 4a, 4b are exposed from silicon nitride film 11. Silicon nitride film 11 is formed by the same method as that of silicon nitride film 10.

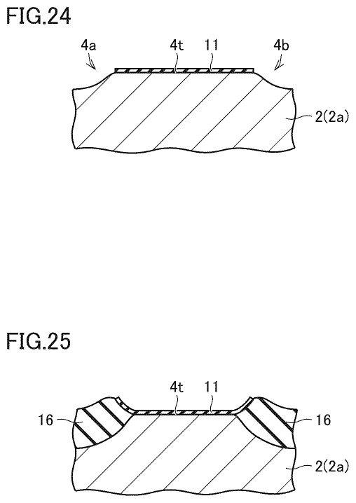

Referring to FIG. 25, silicon member 2 is placed in the thermal oxidation furnace (not shown). Using silicon nitride film 11 as a mask, a part of silicon member 2 is oxidized (locally oxidized) to change the part of silicon member 2 into silicon oxide film 16. Specifically, a portion of silicon member 2, which is exposed from silicon nitride film 11, and a portion of silicon member 2, which is located under the peripheral edge portion of silicon nitride film 11, are changed into silicon oxide film 16. Silicon oxide film 16 is formed to wrap around below the peripheral edge portion of silicon nitride film 11 and lifts up the peripheral edge portion of silicon nitride film 11. Wrapping around below the peripheral edge portion of silicon nitride film 11 by silicon oxide film 16 can be achieved with high reproducibility and high dimensional accuracy. Silicon member 2 is taken out of the thermal oxidation furnace.

Referring to FIG. 26, silicon nitride film 11 is selectively removed by dry etching using CF-based plasma or the like or by wet etching using a hot phosphoric acid or the like.

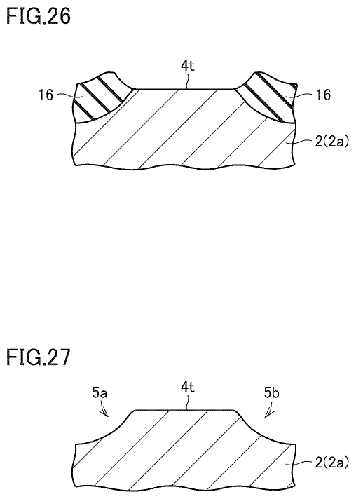

Referring to FIG. 27, silicon oxide film 16 is selectively removed by a hydrofluoric acid solution, a hydrofluoric acid vapor, or the like to form step portions 5a, 5b in silicon member 2. Through the steps shown in FIGS. 24 to 27, step portion 4a (see FIG. 23) becomes step portion 5a, and step portion 4b (see FIG. 23) becomes step portion 5b. Step portion 5a is higher or deeper than step portion 4a. Step portion 5b is higher or deeper than step portion 4b. Step portion 5b faces step portion 5a in the in-plane direction (right-left direction in FIG. 27). Top surface 4t is disposed between step portion 5a and step portion 5b and is connected to step portion 5a and step portion 5b.

Referring to FIG. 28, silicon nitride film 12 is formed on top surface 4t of silicon member 2. Step portions 5a, 5b are exposed from silicon nitride film 12. Silicon nitride film 12 is formed in the same manner as that of silicon nitride film 10.

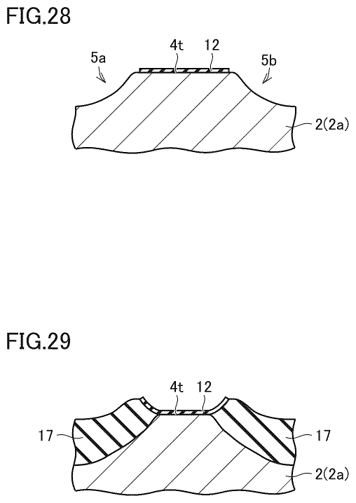

Referring to FIG. 29, silicon member 2 is placed in the thermal oxidation furnace (not shown). Using silicon nitride film 12 as a mask, a part of silicon member 2 is oxidized (locally oxidized) to change the part of silicon member 2 into silicon oxide film 17. Specifically, a portion of silicon member 2, which is exposed from silicon nitride film 12, and a portion of silicon member 2, which is located under the peripheral edge portion of silicon nitride film 12, are changed into silicon oxide film 17. Silicon oxide film 17 is formed to wrap around below the peripheral edge portion of silicon nitride film 12 and lifts up the peripheral edge portion of silicon nitride film 12. Wrapping around below the peripheral edge portion of silicon nitride film 12 by silicon oxide film 17 can be achieved with high reproducibility and high dimensional accuracy. Silicon member 2 is taken out of the thermal oxidation furnace.

Referring to FIG. 30, silicon nitride film 12 is selectively removed by dry etching using CF-based plasma or the like or by wet etching using phosphoric acid or the like.

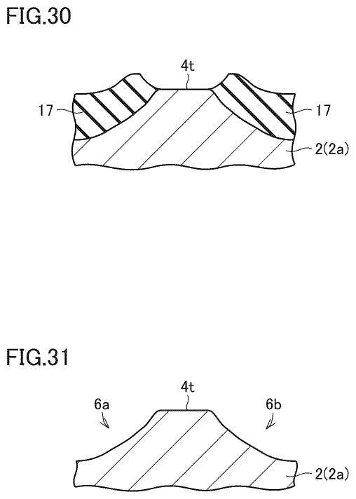

Referring to FIG. 31, silicon oxide film 17 is selectively removed by a hydrofluoric acid solution, a hydrofluoric acid vapor, or the like to form step portions 6a, 6b in silicon member 2. Through the steps shown in FIGS. 28 to 31, step portion 5a (see FIG. 27) becomes step portion 6a, and step portion 5b (see FIG. 27) becomes step portion 6b. Step portion 6a is higher or deeper than step portion 5a. Step portion 6b is higher or deeper than step portion 5b. Step portion 6b faces step portion 6a in the in-plane direction (right-left direction in FIG. 31). Top surface 4t is disposed between step portion 6a and step portion 6b and is connected to step portion 6a and step portion 6b.

Referring to FIG. 32, silicon nitride film 13 is formed on top surface 4t of silicon member 2. Step portions 6a, 6b are exposed from silicon nitride film 13. Silicon nitride film 13 is formed in the same manner as that of silicon nitride film 10.

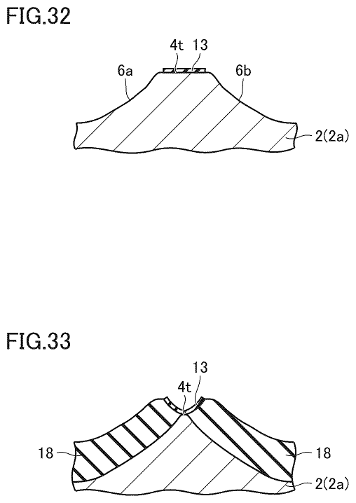

Referring to FIG. 33, silicon member 2 is placed in the thermal oxidation furnace (not shown). Using silicon nitride film 13 as a mask, a part of silicon member 2 is oxidized (locally oxidized) to change the part of silicon member 2 into silicon oxide film 18. Specifically, a portion of silicon member 2, which is exposed from silicon nitride film 13, and a portion of silicon member 2, which is located under the peripheral edge portion of silicon nitride film 13, are changed into silicon oxide film 18. Silicon oxide film 18 is formed to wrap around below the peripheral edge portion of silicon nitride film 13 and lifts up the peripheral edge portion of silicon nitride film 13. Wrapping around below the peripheral edge portion of silicon nitride film 13 by silicon oxide film 18 can be achieved with high reproducibility and high dimensional accuracy. Silicon member 2 is taken out of the thermal oxidation furnace.

Referring to FIG. 34, silicon nitride film 13 is selectively removed by dry etching using CF-based plasma or the like or by wet etching using a hot phosphoric acid or the like.

Silicon oxide film 18 is selectively removed by a hydrofluoric acid solution, a hydrofluoric acid vapor, or the like to form smooth side surfaces 3a, 3b (see FIG. 19) in silicon member 2. Step portion 6a (see FIG. 31) becomes smooth side surface 3a, and step portion 6b (see FIG. 31) becomes smooth side surface 3b. Smooth side surface 3a is higher or deeper than step portion 6a. Smooth side surface 3b is higher or deeper than step portion 6b. Smooth side surface 3b faces smooth side surface 3a in the in-plane direction (right-left direction in FIG. 19). Top surface 4t is disposed between side surface 3a and side surface 3b and is connected to side surface 3a and side surface 3b. Thus, relief-type diffraction grating 1 shown in FIGS. 18 and 19 is obtained.

In the present embodiment, the local oxidation step and the step of selectively removing a silicon oxide film are each performed four times, but depending on the height of protrusion 3, the local oxidation step and the step of selectively removing a silicon oxide film may be each performed n number of times (where n is a natural number), or the thickness of the silicon oxide film produced in the local oxidation step may be adjusted.

The method of manufacturing relief-type diffraction grating 1 of the present embodiment achieves the following advantageous effects in addition to the advantageous effects of the method of manufacturing relief-type diffraction grating 1 of Embodiment 1.

The method of manufacturing relief-type diffraction grating 1 of the present embodiment further includes the steps of: forming a second silicon nitride film (e.g., silicon nitride film 11) on top surface 4t of silicon member 2; oxidizing silicon member 2 using the second silicon nitride film as a mask to change a part of silicon member 2 into a second silicon oxide film (e.g., silicon oxide film 16); removing the second silicon nitride film; and selectively removing the second silicon oxide film. In selectively removing the first silicon oxide film (e.g., silicon oxide film 15), a second step portion (e.g., step portion 4b) that faces the first step portion (e.g., step portion 4a) is formed. Top surface 4t of silicon member 2 is connected to the first step portion and the second step portion. In oxidizing silicon member 2 using the second silicon nitride film as a mask, the first step portion and the second step portion are exposed from the second silicon nitride film. Each of protrusions 3 of relief-type diffraction grating 1 has a smooth side surface (side surface 3a, 3b).

Oxidation (local oxidation) of silicon member 2 using the silicon nitride film as a mask can form a silicon oxide film with higher accuracy. Then, selective removal of the silicon oxide film manufactures relief-type diffraction grating 1. As a result, even if the height of each of protrusions 3 is increased, relief-type diffraction grating 1 with higher dimensional accuracy can be manufactured.

In addition, relief-type diffraction grating 1 of the present embodiment has no edge portions on each of side surfaces 3a, 3b of protrusion 3, and no light scattering occurs at the edge portion. The method of manufacturing relief-type diffraction grating 1 according to the present embodiment can manufacture relief-type diffraction grating 1 having higher diffraction efficiency.

### Embodiment 3

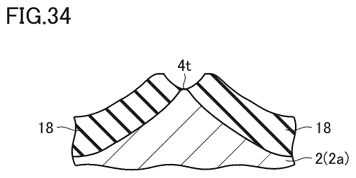

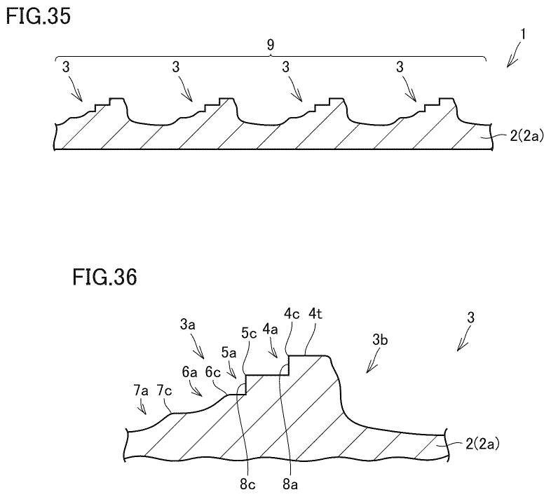

Relief-type diffraction grating 1 of Embodiment 3 will be described with reference to FIGS. 35 and 36. Relief-type diffraction grating 1 of the present embodiment includes a similar configuration to that of relief-type diffraction grating 1 of Embodiment 1 but is different from relief-type diffraction grating 1 of Embodiment 1 in the following respects.

In relief-type diffraction grating 1 of the present embodiment, step portion 4a has an angulated edge portion 4c. Step portion 5a has an angulated edge portion 5c. In this specification, the angulated edge portion means that the minimum radius of curvature of the edge portion is less than one-tenth of the diffraction wavelength of relief-type diffraction grating 1. Step portion 4a has a flat side surface 8a. Step portion 5a has a flat side surface 8c. Side surface 3b is a smooth side surface.

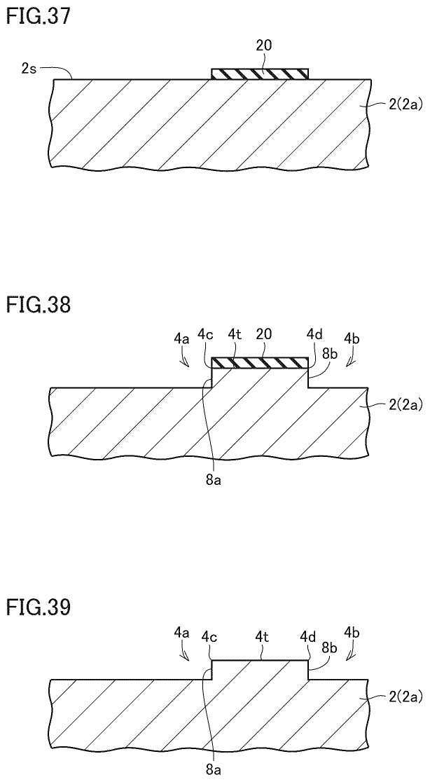

Referring to FIGS. 37 to 49, the method of manufacturing relief-type diffraction grating 1 of Embodiment 3 will be described.

Referring to FIG. 37, a photoresist 20 is formed on main surface 2s of silicon member 2. A part of main surface 2s of silicon member 2 is covered with photoresist 20. The remaining part of main surface 2s of silicon member 2 is exposed from photoresist 20. The thickness of photoresist 20 is 1 μm or more. Photoresist 20 is formed by applying the photoresist to the entire main surface 2s of silicon member 2 and exposing the photoresist to light and developing the photoresist.

Referring to FIG. 38, using photoresist 20 as an etching mask, a portion of silicon member 2 which is exposed from photoresist 20 is removed by dry etching such as deep reactive ion etching (DRIE). Step portions 4a, 4b are formed in silicon member 2. Step portion 4a has flat side surface 8a and angulated edge portion 4c.

Step portion 4b faces step portion 4a in the in-plane direction (right-left direction in FIG. 38). Step portion 4b has a flat side surface 8b and angulated edge portion 4d. Flat side surfaces 8a, 8b may be perpendicular to top surface 4t. Top surface 4t is disposed between step portion 4a and step portion 4b and is connected to step portion 4a and step portion 4b.

Referring to FIG. 39, photoresist 20 is removed from silicon member 2 using oxygen plasma or an organic solvent such as acetone.

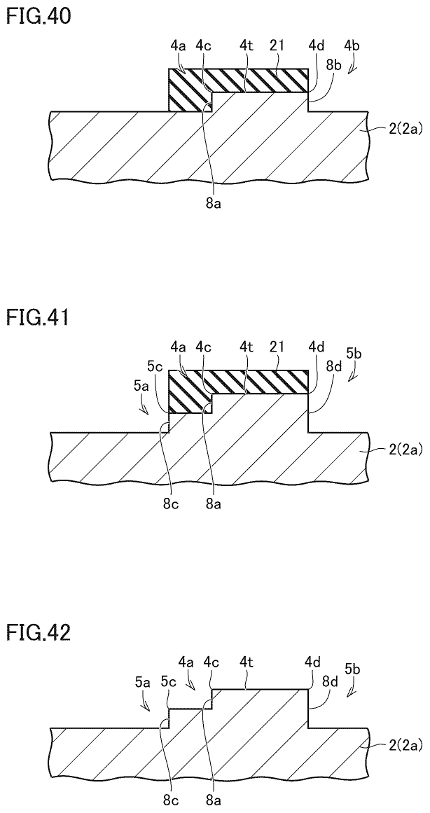

Referring to FIG. 40, a photoresist 21 is formed on top surface 4t of silicon member 2 and on step portion 4a. Step portion 4b and a portion of silicon member 2, which is opposite to top surface 4t relative to step portion 4a in the in-plane direction (right-left direction in FIG. 40), are exposed from photoresist 21. Photoresist 21 is thicker than photoresist 20. Photoresist 21 is formed in the same manner as that of photoresist 20.

Referring to FIG. 41, using photoresist 21 as an etching mask, a portion of silicon member 2, which is exposed from photoresist 21, is removed by dry etching such as deep reactive ion etching (DRIE). Step portions 5a, 5b are formed in silicon member 2. Step portion 5a has flat side surface 8c and angulated edge portion 5c. Through the steps shown in FIGS. 40 to 42, step portion 4b (see FIG. 39) becomes step portion 5b. Step portion 5b is higher or deeper than step portion 4b. Step portion 5b faces step portions 4a, 5a in the in-plane direction (right-left direction in FIG. 41). Step portion 5b has a flat side surface 8d and an angulated edge portion 4d. Flat side surfaces 8c, 8d may be perpendicular to top surface 4t. Top surface 4t is disposed between step portion 4a and step portion 5b and is connected to step portion 4a and step portion 5b.

Referring to FIG. 42, photoresist 21 is removed from silicon member 2 using oxygen plasma or an organic solvent such as acetone.

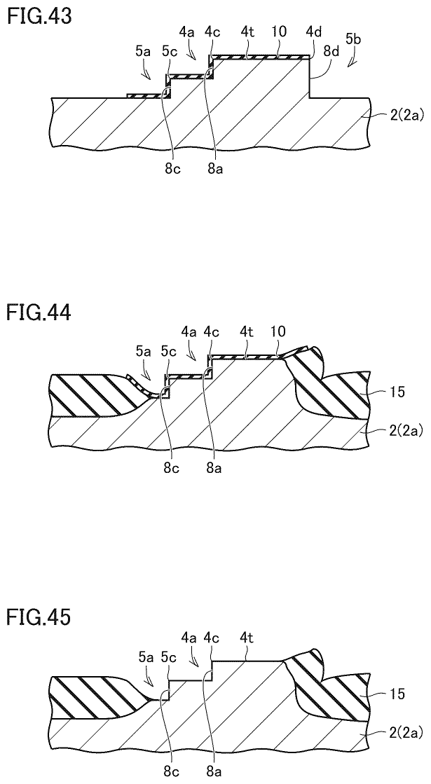

Referring to FIG. 43, silicon nitride film 10 is formed on top surface 4t of silicon member 2 and on step portions 4a, 5a. Step portion 5b and a portion of silicon member 2, which is opposite to top surface 4t relative to step portion 5a in the in-plane direction (right-left direction in FIG. 43), are exposed from silicon nitride film 10. Silicon nitride film 10 of the present embodiment is formed in the same manner as that of silicon nitride film 10 of Embodiment 1. Silicon nitride film 10 is thinner than each of photoresists 20, 21. The thickness of silicon nitride film 10 is in the range of, for example, 0.1 μm to 0.3 μm.

Referring to FIG. 44, silicon member 2 is placed in the thermal oxidation furnace (not shown). Using silicon nitride film 10 as a mask, a part of silicon member 2 is oxidized (locally oxidized) to change the part of silicon member 2 into silicon oxide film 15. Specifically, a portion of silicon member 2, which is exposed from silicon nitride film 10, and a portion of silicon member 2, which is located under the peripheral edge portion of silicon nitride film 10, are changed into silicon oxide film 15. Silicon oxide film 15 is formed to wrap around below the peripheral edge portion of silicon nitride film 10 and lifts up the peripheral edge portion of silicon nitride film 10. Wrapping around below the peripheral edge portion of silicon nitride film 10 by silicon oxide film 15 can be achieved with high reproducibility and high dimensional accuracy. Silicon member 2 is taken out of the thermal oxidation furnace.

Referring to FIG. 45, silicon nitride film 10 is selectively removed by dry etching using CF-based plasma or the like or by wet etching using a hot phosphoric acid or the like.

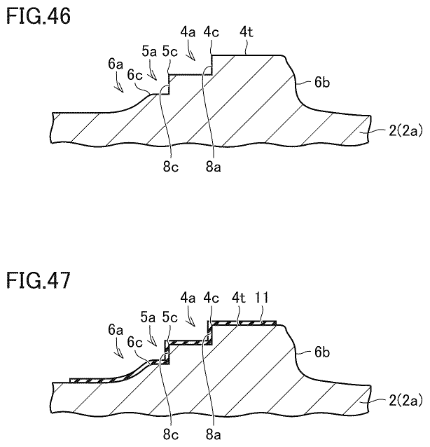

Referring to FIG. 46, silicon oxide film 15 is selectively removed by a hydrofluoric acid solution, a hydrofluoric acid vapor, or the like to form step portions 6a, 6b in silicon member 2. Step portion 6a has smooth edge portion 6c. Edge portion 6c of step portion 6a is smoothed by a local oxidation step (see FIG. 44) and a step of selectively removing a silicon oxide film (see FIG. 46). Step portion 5b (see FIG. 42) becomes step portion 6b by the steps shown in FIGS. 43 to 46. Step portion 6b is higher or deeper than step portion 5b. Step portion 6b faces step portions 4a, 5a, 6a in the in-plane direction (right-left direction in FIG. 46). Step portion 6b has a smooth side surface. The side surface of step portion 6b is steeper than step portion 6a. Top surface 4t is disposed between step portion 4a and step portion 6b and is connected to step portion 4a and step portion 6b.

Referring to FIG. 47, silicon nitride film 11 is formed on top surface 4t of silicon member 2 and on step portions 4a, 5a, 6a. Step portion 6b and a portion of silicon member 2, which is opposite to top surface 4t relative to step portion 6a in the in-plane direction (right-left direction in FIG. 47), are exposed from silicon nitride film 11. Silicon nitride film 11 of the present embodiment is formed in the same manner as that of silicon nitride film 10 of the present embodiment. Silicon nitride film 11 is thinner than each of photoresists 20, 21. The thickness of silicon nitride film 11 is in the range of, for example, 0.1 μm to 0.3 μm.

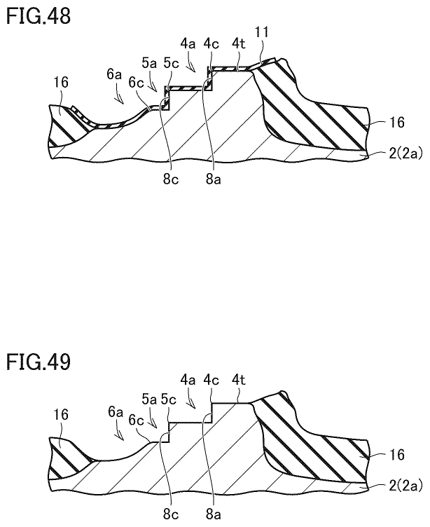

Referring to FIG. 48, silicon member 2 is placed in the thermal oxidation furnace (not shown). Using silicon nitride film 11 as a mask, a part of silicon member 2 is oxidized (locally oxidized) to change the part of silicon member 2 into silicon oxide film 16. Specifically, a portion of silicon member 2, which is exposed from silicon nitride film 11, and a portion of silicon member 2, which is located under the peripheral edge portion of silicon nitride film 11, are changed into silicon oxide film 16. Silicon oxide film 16 is formed to wrap around below the peripheral edge portion of silicon nitride film 11 and lifts up the peripheral edge portion of silicon nitride film 11. Wrapping around below the peripheral edge portion of silicon nitride film 11 by silicon oxide film 16 can be achieved with high reproducibility and high dimensional accuracy. Silicon member 2 is taken out of the thermal oxidation furnace.

Referring to FIG. 49, silicon nitride film 11 is selectively removed by dry etching using CF-based plasma or the like or by wet etching using a hot phosphoric acid or the like.

Silicon oxide film 16 is selectively removed by a hydrofluoric acid solution, a hydrofluoric acid vapor, or the like to form step portion 7a (see FIG. 36) in silicon member 2. Step portion 7a has smooth edge portion 7c (see FIG. 36). Edge portion 7c of step portion 7a is smoothed by a local oxidation step (see FIG. 48) and a step of selectively removing a silicon oxide film. Step portion 6b (see FIG. 46) becomes smooth side surface 3b (see FIG. 36). Side surface 3b is higher or deeper than the side surface of step portion 6b. Side surface 3b faces step portions 4a, 5a, 6a, 7a in the in-plane direction (right-left direction in FIG. 36). Side surface 3b is steeper than step portions 6a, 7a. Side surface 3b is gentler than the side surface of step portion 4a and the side surface of step portion 5a. Thus, relief-type diffraction grating 1 shown in FIGS. 35 and 36 is obtained.

In the present embodiment, the step of removing silicon member 2 using a photoresist is performed twice in order to form two step portions 4a, 5a, and then, the local oxidation step and the step of selectively removing a silicon oxide film are each performed twice in order to form two step portions 6a, 7a, but the step of removing silicon member 2 using a photoresist may be performed m number of times (where m is a natural number) in order to form m number of step portions, and then, the local oxidation step and the step of selectively removing a silicon oxide film may be each performed n number of times (where n is a natural number) in order to form n number of step portions below the n number of step portions.

The method of manufacturing relief-type diffraction grating 1 of the present embodiment achieves the following advantageous effects in addition to the advantageous effects of the method of manufacturing relief-type diffraction grating 1 of Embodiment 1.

The method of manufacturing relief-type diffraction grating 1 of the present embodiment further includes the steps of: forming a photoresist (e.g., photoresist 20) on silicon member 2; dry-etching a part of silicon member 2 using the photoresist as an etching mask to form a second step portion (e.g., step portion 4a) in silicon member 2; and removing the photoresist. The first silicon nitride film (e.g., silicon nitride film 10) is formed on the second step portion and on top surface 4t of silicon member 2 connected to the second step portion. The first step portion (e.g., step portion 6a) is located below the second step portion. Each of protrusions 3 of relief-type diffraction grating 1 has a plurality of height levels.

When an upper step portion (e.g., step portion 4a, 5a) is formed by etching using a photoresist as a mask, the photoresist can be made relatively thin. Thus, also, etching using a photoresist as a mask can form the upper step portion with relatively high dimensional accuracy. However, when a lower step portion (e.g., step portion 6a, 7a) is formed by etching using a photoresist as a mask, a thick photoresist patterned is required. When the thick photoresist is patterned by exposure to light and development, the thick photoresist cannot be patterned with high accuracy due to defocusing of the light used for exposure to light. Thus, when the lower step portion (e.g., step portion 6a, 7a) is formed by etching using a photoresist as a mask, the dimensional accuracy of the lower step portion (e.g., step portion 6a, 7a) decreases.

In contrast, in the present embodiment, oxidation (local oxidation) of silicon member 2 using a silicon nitride mask, which is thinner than the photoresist, and selective removal of the silicon oxide film are used in order to form the lower step portion (e.g., step portion 6a, 7a). Oxidation (local oxidation) of silicon member 2 using the silicon nitride film as a mask can form a silicon oxide film with higher dimensional accuracy. Relief-type diffraction grating 1 is manufactured by selectively removing the silicon oxide film. As a result, the dimensional accuracy of the lower step portion (e.g., step portion 6a, 7a) is improved. The method of manufacturing relief-type diffraction grating 1 according to the present embodiment can manufacture relief-type diffraction grating 1 having higher dimensional accuracy.

In addition, the dimension of protrusions 3 in the in-plane direction can be adjusted by etching using a photoresist as a mask to form the upper step portion (e.g., step portion 4a, 5a). This enables adjustment of the diffraction wavelength of relief-type diffraction grating 1.

In the method of manufacturing relief-type diffraction grating 1 of the present embodiment, in removing a part of silicon member 2, a flat side surface (e.g., flat side surface 8b) facing the second step portion (e.g., step portion 4a) is formed in silicon member 2. In oxidizing silicon member 2, the flat side surface is exposed from the first silicon nitride film (e.g., silicon nitride film 10). In selectively removing the first silicon oxide film (e.g., silicon oxide film), a side surface (e.g., side surface 6b), which faces a first step portion (e.g., step portion 6a) and a second step portion and is smoother than the first step portion and the second step portion, is formed in silicon member 2.

Therefore, the dimension of protrusion 3 in the in-plane direction can be adjusted. This enables adjustment of the diffraction wavelength of relief-type diffraction grating 1.

### Embodiment 4

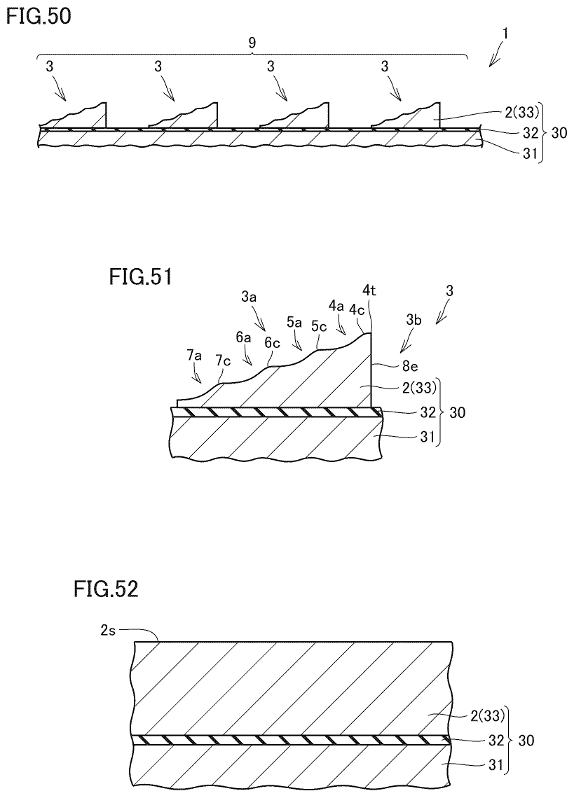

Relief-type diffraction grating 1 of Embodiment 4 will be described with reference to FIGS. 50 and 51. Relief-type diffraction grating 1 of the present embodiment includes a similar configuration to that of relief-type diffraction grating 1 of Embodiment 1 but is different from relief-type diffraction grating 1 of Embodiment 1 in the following respects.

In the present embodiment, silicon member 2 is a silicon layer 33 of a silicon-on-insulator (SOI) substrate 30. SOI substrate 30 includes a silicon substrate 31, a SiO₂ insulating layer 32, and a silicon layer 33. SiO₂ insulating layer 32 is located between silicon substrate 31 and silicon layer 33. Relief-type diffraction grating 1 is formed in silicon layer 33.

Side surface 3b of each of protrusions 3 is a flat side surface 8e facing step portions 4a, 5a, 6a, 7a. Side surface 3b may be perpendicular to top surface 4t. Side surface 3b may extend to SiO₂ insulating layer 32.

Referring to FIGS. 52 to 54, the method of manufacturing relief-type diffraction grating 1 of Embodiment 4 will be described.

Referring to FIG. 52, SOI substrate 30 is prepared. SOI substrate 30 includes silicon substrate 31, SiO₂ insulating layer 32, and silicon layer 33. SiO₂ insulating layer 32 is located between silicon substrate 31 and silicon layer 33. Silicon layer 33 has main surface 2s opposite to SiO₂ insulating layer 32.

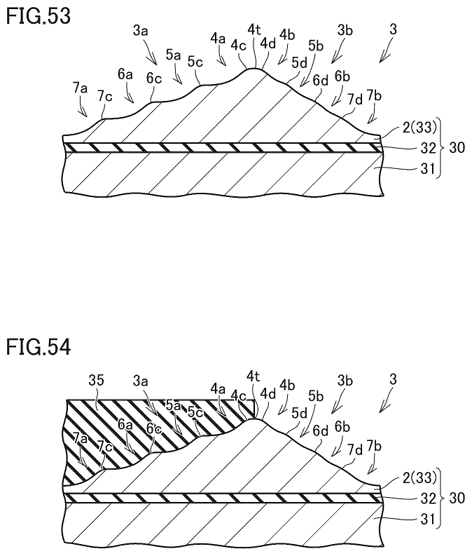

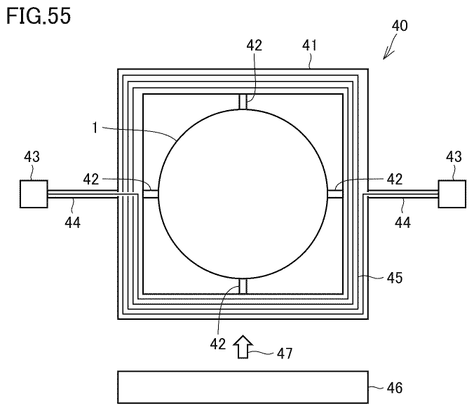

Referring to FIG. 53, relief-type diffraction grating 1 is formed in silicon layer 33 by a manufacturing method similar to the method of manufacturing relief-type diffraction grating 1 of Embodiment 1. Relief-type diffraction grating 1 includes periodic uneven structure 9. Periodic uneven structure 9 of relief-type diffraction grating 1 includes a plurality of protrusions 3 disposed periodically. Each of protrusions 3 includes side surface 3a, side surface 3b facing side surface 3a, and top surface 4t. Step portions 4a, 5a, 6a, 7a are formed in side surface 3a. Step portions 4b, 5b, 6b, 7b are formed in side surface 3b.

Referring to FIG. 54, a photoresist 35 is formed on top surface 4t of silicon layer 33 and on step portions 4a, 5a, 6a, 7a. Step portions 4b, 5b, 6b, 7b are exposed from photoresist 35. Photoresist 35 is thicker than silicon nitride films 10, 11, 12, 13 of Embodiment 1. Photoresist 35 is formed in the same manner as that of photoresist 20 of Embodiment 3.

Using photoresist 35 as an etching mask, a portion of silicon layer 33, which is exposed from photoresist 35, is removed by dry etching such as deep reactive ion etching (DRIE). Side surface 3b (see FIG. 51), which is flat side surface 8e, is formed. In the step of etching silicon layer 33, SiO₂ insulating layer 32 functions as an etch-stop layer. Then, photoresist 21 is removed using oxygen plasma or an organic solvent such as acetone. In this way, relief-type diffraction grating 1 shown in FIGS. 50 and 51 is obtained.

The method of manufacturing relief-type diffraction grating 1 of the present embodiment achieves the following advantageous effects in addition to the advantageous effects of the method of manufacturing relief-type diffraction grating 1 of Embodiment 1.

The method of manufacturing relief-type diffraction grating 1 of the present embodiment further includes the step of etching silicon member 2 (e.g., silicon layer 33) to form flat side surface 8e facing the first step portion (e.g., step portion 4a).

Thus, the dimension of protrusion 3 in the in-plane direction can be adjusted. This enables adjustment of the diffraction wavelength of relief-type diffraction grating 1.

In the method of manufacturing relief-type diffraction grating 1 of the present embodiment, silicon member 2 is silicon layer 33 of silicon-on-insulator substrate 30.

Relief-type diffraction grating 1 of the present embodiment is formed in silicon layer 33, which is formed of a single material, that is, silicon. Thus, the method of manufacturing relief-type diffraction grating 1 according to the present embodiment can manufacture relief-type diffraction grating 1 with excellent temperature stability of diffraction efficiency compared to the relief-type diffraction grating of the comparative example, which is formed of a plurality of materials with different linear expansion coefficients.

In the step of etching silicon layer 33, SiO₂ insulating layer 32 of the silicon-on-insulator substrate functions as an etch stop layer. Thus, the height dimension of protrusion 3 is accurately determined. The method of manufacturing relief-type diffraction grating 1 according to the present embodiment can manufacture relief-type diffraction grating 1 with higher dimensional accuracy.

### Embodiment 5

Referring to 55, an optical scanning device 40 of Embodiment 5 will be described. Optical scanning device 40 is an example in which relief-type diffraction grating 1 of each of Embodiment 1 to Embodiment 4 is used.

Optical scanning device 40 includes relief-type diffraction grating 1, a frame 41, beams 42, 44, anchors 43, a coil 45, and a magnetic field generator 46.

Relief-type diffraction grating 1 is coupled to frame 41 via beams 42. Frame 41 is coupled to anchor 43 via beam 44. Coil 45 is provided on frame 41. Coil 45 is wound around relief-type diffraction grating 1. Magnetic field generator 46 generates a magnetic field 47. Magnetic field generator 46 is, for example, a permanent magnet.

When an alternating current is applied to coil 45, an electromagnetic force is applied to frame 41 by the alternating current flowing through the coil and magnetic field 47 from magnetic field generator 46. Frame 41 oscillates around beams 44 due to this electromagnetic force. Relief-type diffraction grating 1 oscillates together with frame 41 and scans the light incident on relief-type diffraction grating 1.

The advantageous effects of optical scanning device 40 of the present embodiment are achieved.

Optical scanning device 40 includes relief-type diffraction grating 1. Relief-type diffraction grating 1 has higher dimensional accuracy. Thus, relief-type diffraction grating 1 has high diffraction efficiency. Optical scanning device 40 according to the present embodiment can scan the light incident on relief-type diffraction grating 1 with low optical loss.

It should be understood that Embodiments 1 to 5 disclosed herein are illustrative and non-restrictive in every respect. As long as there is no contradiction, at least two of Embodiments 1 to 5 disclosed herein may be combined. For example, the relief-type diffraction grating of each of Embodiments 1 to 3 may be formed in silicon layer 33 of SOI substrate 30 as in Embodiment 4. It is therefore intended that the scope of the present disclosure is defined by claims, rather than the description above, and encompasses all modifications and variations equivalent in meaning and scope to the claims.

### REFERENCE SIGNS LIST

1 relief-type diffraction grating; 2 silicon member; 2a silicon substrate; 2s main surface; 3 protrusion; 3a, 3b, 6b side surface; 4a, 4b, 5a, 5b, 6a, 6b, 7a, 7b step portion: 4c, 4d, 5c, 5d, 6c, 6d, 7c, 7d edge portion; 4t top surface; 8a, 8b, 8c, 8d, 8e flat side surface; 9 periodic uneven structure; 10, 11, 12, 13 silicon nitride film; 15, 16, 17, 18 silicon oxide film; 20, 21, 35 photoresist; 30 silicon-on-insulator substrate; 31 silicon substrate; 33 silicon layer; 32 insulating layer; 40 optical scanning device; 41 frame; 42, 44 beam; 43 anchor; 45 coil; 46 magnetic field generator; 47 magnetic field.

1. A method of manufacturing a relief-type diffraction grating, the method comprising:
forming a first silicon nitride film on a silicon member;
oxidizing the silicon member using the first silicon nitride film as a mask to change a part of the silicon member into a first silicon oxide film;
removing the first silicon nitride film; and
selectively removing the first silicon oxide film to form a first step portion in the silicon member.

2. The method of manufacturing a relief-type diffraction grating according to claim 1, wherein the first step portion has a smooth edge portion.

3. The method of manufacturing a relief-type diffraction grating according to claim 1, the method further comprising:
forming a second silicon nitride film on a top surface of the silicon member connected to the first step portion and on the first step portion;
oxidizing the silicon member using the second silicon nitride film as a mask to change a part of the silicon member into a second silicon oxide film;
removing the second silicon nitride film; and
selectively removing the second silicon oxide film to form, in the silicon member, a second step portion connected to the first step portion,
wherein each of protrusions of the relief-type diffraction grating has a plurality of height levels.

4. The method of manufacturing a relief-type diffraction grating according to claim 1, the method further comprising:
forming a second silicon nitride film on a top surface of the silicon member;
oxidizing the silicon member using the second silicon nitride film as a mask to change a part of the silicon member into a second silicon oxide film;
removing the second silicon nitride film; and
selectively removing the second silicon oxide film, wherein
in selectively removing the first silicon oxide film, a second step portion that faces the first step portion is formed,
the top surface of the silicon member is connected to the first step portion and the second step portion,
in oxidizing the silicon member using the second silicon nitride film as a mask, the first step portion and the second step portion are exposed from the second silicon nitride film, and
each of protrusions of the relief-type diffraction grating has a smooth side surface.

5. The method of manufacturing a relief-type diffraction grating according to claim 1, the method further comprising:
forming a photoresist on the silicon member;
dry-etching a part of the silicon member using the photoresist as an etching mask to form a second step portion in the silicon member; and
removing the photoresist, wherein
the first silicon nitride film is formed on the second step portion and on a top surface of the silicon member connected to the second step portion,
the first step portion is located below the second step portion, and
each of protrusions of the relief-type diffraction grating has a plurality of height levels.

6. The method of manufacturing a relief-type diffraction grating according to claim 5, wherein
in removing the part of the silicon member, a flat side surface that faces the second step portion is formed in the silicon member,
in oxidizing the silicon member, the flat side surface is exposed from the first silicon nitride film, and
in selectively removing the first silicon oxide film, a side surface is formed in the silicon member, the side surface facing the first step portion and the second step portion and being smoother than the first step portion and the second step portion.

7. The method of manufacturing a relief-type diffraction grating according to claim 1, further comprising etching the silicon member to form a flat side surface that faces the first step portion.

8. The method of manufacturing a relief-type diffraction grating according to claim 1, wherein the silicon member is a silicon substrate.

9. The method of manufacturing a relief-type diffraction grating according to claim 1, wherein the silicon member is a silicon layer of a silicon-on-insulator substrate.
